(19) United States
(12) Patent Application Publication
(10) Pub. No.: US 2004/0172990 A1
(43) Pub. Date: Sep. 9, 2004

(54) Locking device for aluminum staging poles

(76) Inventor: David O' Rouke, Central Falls, RI (US)

Correspondence Address: Cari & Offenberg, 494 Broadway, Newport, RI, 02840, US

(21) Appl. No.: 10/383,063

(22) Filed: Mar. 6, 2003

(51) Int. Cl. E05B 73/00; E05B 69/00

(52) U.S. Cl. 70/58; 70/14

(57) ABSTRACT

A locking device designed for use with aluminum staging poles to prevent theft of the aluminum poles. Aluminum staging poles are approximately three inches square aluminum with a heavy rubber pad attached to one side of the pole and are the most preferred type of staging poles. The locking device of the present invention provides a means for securing the aluminum poles while in position at the job site to prevent removal. The locking device is comprised of two interconnecting plates that wrap around the pole and provide an aperture through which a chain or cable can be fed and secured to a non-movable structure. Gripping feet on the locking device grip into the rubber pad of the aluminum pole to prevent the locking device from being slid off of the pole while in use.

This is a utility application dating back to Provisional Application No. 60/380,872 with a filing date of Mar. 4, 2002.

### FIELD OF THE INVENTION

This invention relates to locking devices specifically to a locking device for aluminum staging poles.

### BACKGROUND OF THE INVENTION

Aluminum staging poles are used in the construction business in conjunction with pump jacks and are the latest, most preferred type of staging poles. Aluminum staging poles are approximately three inches square aluminum with a heavy rubber pad attached to one side of the pole. They are commonly available in lengths up to twenty four feet and can be joined with others to extend this length. The poles have four holes in each pole at the bottom end. The holes are about ½ inch in diameter and are used for the connection of the pump jack but they are not large enough for a chain or steel cable to thread through for security purposes.

There are no known locks designed for use with aluminum staging poles to prevent theft of the poles from the job site. As the poles are made of aluminum, they are relatively light weight that a thief could carry them from the job site quite easily. The owner must take down the staging and try to secure the poles or take them with him to prevent theft. This is quite impractical if the job is to take more than one day for completion. It would be preferable to secure the poles while in place on the site to a non-movable structure. The poles are quite simple in structure and therefore it is difficult to secure with a securing means such as rope, chain or cable about the diameter of the pole. These types of securing means are easily removed by slipping the pole out of the securing means. As well, there is no means on the poles as presently constructed to secure the poles with a chain or cable. There are small holes in the bottom and top ends of the poles but they are too small for strong cables or chains to thread through them and the position of the holes makes it difficult to easily secure the poles while in position.

It is an object of the present invention to provide a locking device to secure aluminum staging poles.

It is an object of the present invention to provide a locking device to secure aluminum staging poles while in position at the job site.

It is a further object of the present invention to provide a locking device for aluminum staging poles that is not easily removable while in use.

It is still a further object of the present invention to provide a locking device for aluminum staging poles that secures the poles to a non-movable structure.

### BRIEF SUMMARY OF THE INVENTION

The present invention is a locking device for aluminum poles designed for use when the owner is not on the job site to prevent theft of the poles. The present invention is a locking mechanism that cannot be easily removed from the poles while in use having an aperture large enough to allow securing means such as heavy rope, chains and cable to feed through the aperture for security purposes. The locking device provides security to the owners of the poles by providing a means of locking the poles to non-movable objects. The lock allows for the chains or cables to be attached to the poles so the poles can be secured to another object.

The locks are designed to be constructed of steel or aluminum and consist of two interlocking parts. The base member is designed to fit against three sides of the square aluminum pole and the front plate interlocks with the base member and fits against the fourth side of the pole. The base member has an aperture for the securing means such as heavy rope, chain or cable to feed through and secure the pole to a non-movable structure.

The locking device of the preferred embodiment has gripping feet on the base member's back plate that grip into a rubber pad on the aluminum pole. When the locking device is properly in place and in use on the pole, the gripping feet prevent the locking device from being removed by sliding off the pole. As an alternative to the gripping feet, the back plate of the base member can be equipped with an extended rod that is fitted into one of the holes that already exist in the aluminum pole. When the locking device is properly in place with the extended rod in a hole of the aluminum pole, the locking device cannot be slid off from the pole which prevents theft.

When the locking device is in place on the aluminum pole, a securing means such as a heavy rope, chain, or cable is fed through the aperture in the extended end of the bottom plate of the base member and then tied, looped, or fed into some other device or holding means on a non-movable structure and finally secured with a locking means such as a combination lock or keyed lock thus preventing the theft of the poles.

Should the non-movable structure have no means for attaching the chain or cable, then a second locking device can act a as holding means by attaching the back plate of the locking device to a building or non-movable structure and thereby provide a means to attach the chain or cable from the pole to the non-movable structure.

### BRIEF DESCRIPTION OF THE DRAWING

FIG. 1 is a front view of the locking device of the preferred embodiment.

FIG. 2 is a side view of the base member and a front view of the front plate which are the two component parts of the locking device.

FIG. 3 is view of the preferred embodiment in place on an aluminum pole.

FIG. 4 is a view showing the extended rod used for holding the device onto the pole.

FIG. 5 shows the alternative embodiment of the extended rod on the back plate of the base member.

FIG. 6 shows the second use of the locking device as a holding means attached by screws to a non-movable structure.

### DETAILED DESCRIPTION OF THE PREFERRED EMBODIMENT

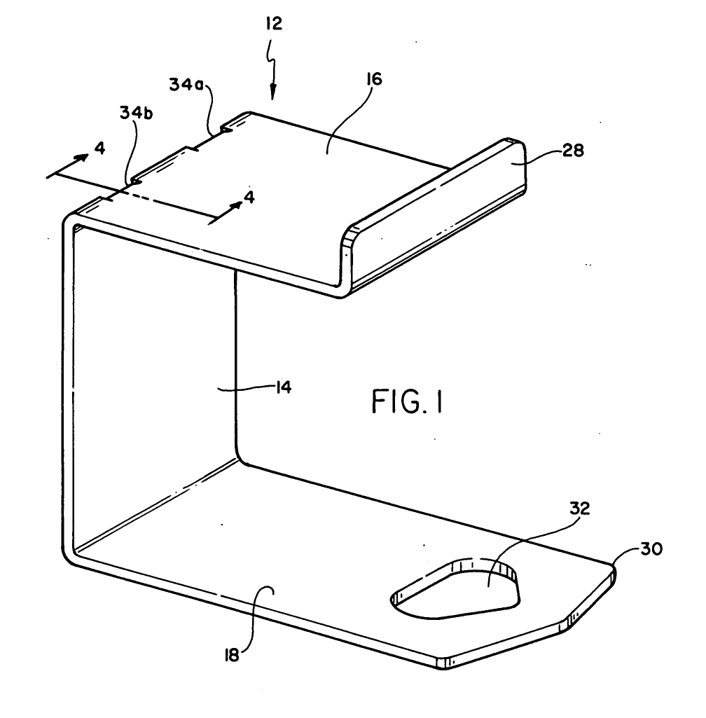

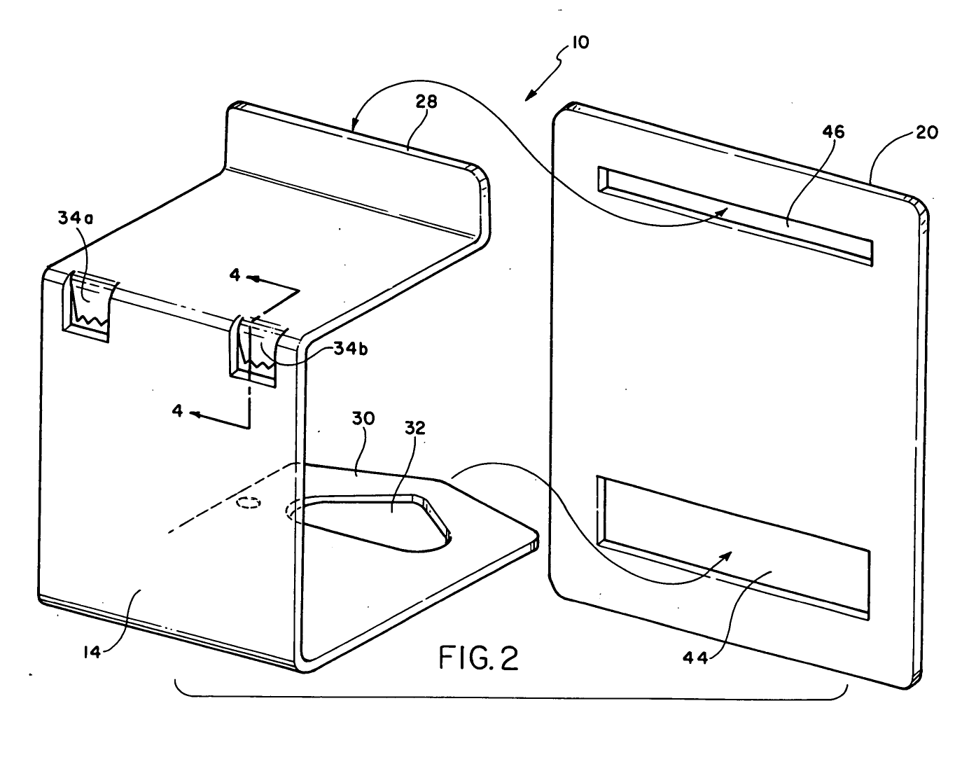

Referring now to the drawings, in which like numerals refer to like parts throughout the several views, FIG. 1. illustrates the locking device assembly 10 in accordance with the preferred embodiment of the present invention. The locking device 10 comprises two parts, a base member 12 and a front plate 20, shown separately in FIG. 2.

Base member 12 is comprised of a back plate 22 is attached at its top edge at a right angle to an outwardly projecting top plate 16. The back plate is attached at its bottom edge to outwardly projecting bottom plate 18 at a right angle. The top plate 16 has a turned up lip 28 that fits into the front plate's top slot. The bottom plate 18 has an extended end 30 with an aperture 32 large enough to pass a cable or chain or rope through for securing the device to a non-movable structure. The extended end 30 fits into the bottom slot of the front plate. The base member is shaped to fit around a square aluminum staging pole.

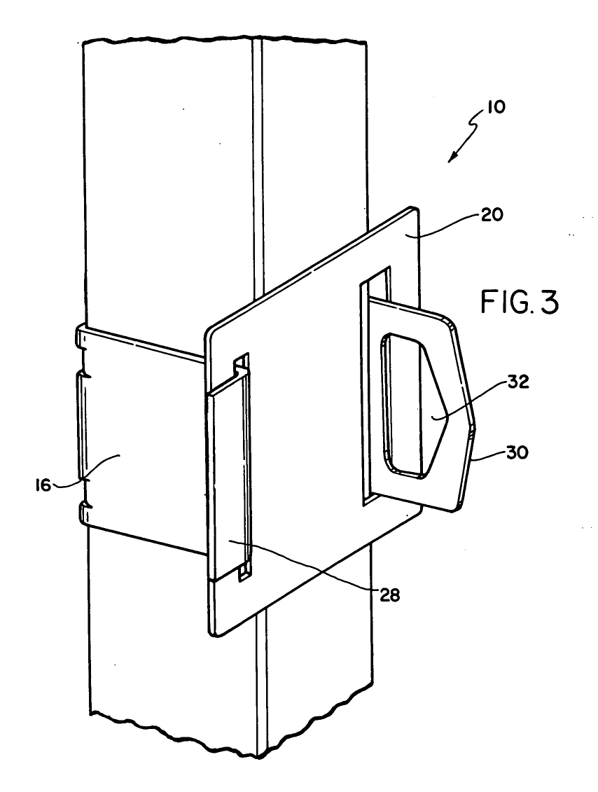

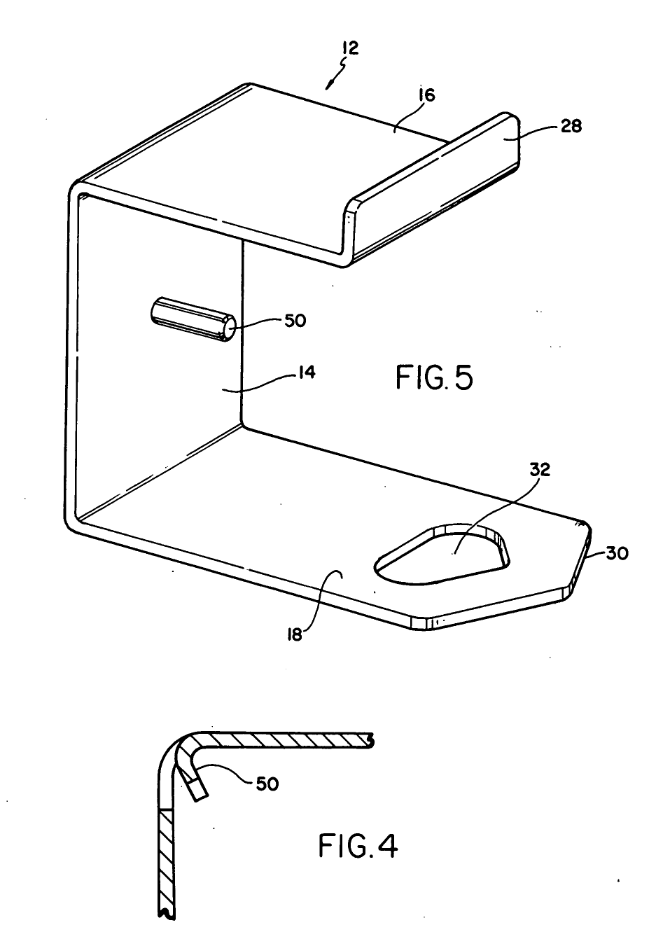

As shown in FIG. 2, the front plate 20 has a top slot 46 and a bottom slot 44. The top slot 46 fits over the turned up lip 28 of the base member 12. The bottom slot 44 is slid over the extended end 30 with the aperture 32 extending past the front plate 20. The entire locking device 10 when assembled is tightly fitted around an aluminum pole as shown in FIG. 3.

As shown in FIG. 2, the back plate 14 is made with gripping feet 34a and 34b which come into frictional contact with a rubber backing disposed along the side of the aluminum pole. Once the front plate 20 is put into position over the turn up lip 28 and the extended end 30, the gripping fee 34a and 34b are pushed out and into the rubber backing and prevent the locking device from sliding off of the aluminum pole. The gripping feet 34 keep the locking device attached to the aluminum pole and prevent removal of the device once it is secured in place with a chain or cable.

FIG. 5 shows another embodiment of the subject invention. The base member 12 is shown with an extended rod 50 threaded through a hole in the center of the back plate 14 that feeds into a preexisting hole in the aluminum pole. This embodiment is used as an alternative to the gripping feet as the extended rod 50 will prevent the locking device from being pulled off the pole or from sliding off the pole.

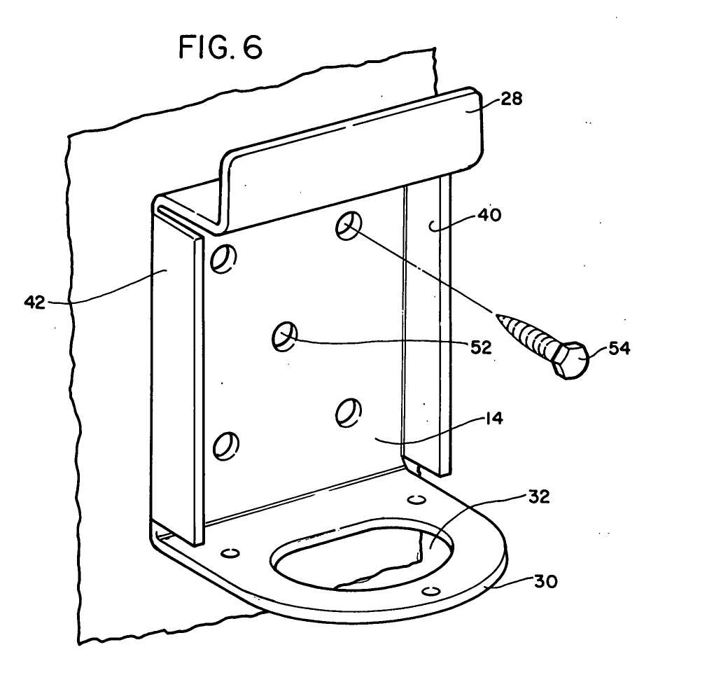

FIG. 6 shows another embodiment of the subject invention. The back plate 14 of the locking device is secured such as by screws 54 to a building or other non-movable structure to be used as a holding means for the chain or cable. The base member 10 is drilled with holes 52 in the back plate 14 and secured by screws 54 to a building or other non-movable structure. There are two side flanges, a first side flange 40 welded to a first side edge of the back plate 14 and a second side flange 42 welded to a second side edge of the back plate 14. The first and second side flanges 40 and 42 prevent removal of the base member 10 from the building or structure as the screws 54 cannot be removed when the front plate 20 is in place. The front plate 20 is attached by the same means as discussed in FIG. 1. The other end of the securing means from the locking device that is attached to the aluminum pole is fed through the hole 52 in the holding device and clamped together by a combination or keyed lock.

What is claimed is:

1. a locking device for aluminum staging poles comprising:
a base member having a flat rigid back plate attached at a top edge at a right angle to an outwardly projecting flat rigid top plate;
said flat back plate back plate attached at a bottom edge at a right angle to an outwardly projecting flat rigid bottom plate;
said top plate having a turned up lip;
said bottom plate having an end extended longer than the turned up lip of the top plate and an aperture in said extended end;
a flat rigid front plate having a top slot to fit onto the turned up lip;
said front plate having a bottom slot to fit over the extended end and thereby fitting at right angles to the top plate and bottom plate;
wherein the base member is fitted against a stage pole so that the back plate, top plate and bottom plate each lie flat against a side of an aluminum staging pole and when the front plate is put into place it lies flat against a fourth side of the aluminum staging pole;
wherein a securing means is fed through the aperture of the bottom plate to secure the aluminum pole to a non-movable structure.

2. A locking device for aluminum staging poles as described in claim 1 further comprising:
one or more gripping feet located on a back side of the back plate of the base member which engage a rubber backing disposed upon the length of the aluminum pole when the front plate is put into position.

3. A locking device for aluminum staging poles as described in claim 1 further comprising;
said back plate having hole in the center for accepting a rod;
said rod extending from a center position on the back plate of the base member to a hole in the aluminum pole.

4. A locking device for aluminum staging poles as described in claim 1 further comprising;
a first side flange on the first side edge of the back plate of the base member; and
a second side flange on the second side edge of the back plate of the base member.
